(19) United States
(12) Patent Application Publication
(10) Pub. No.: US 2016/0323826 A1
(43) Pub. Date: Nov. 3, 2016

(54) MULTIMODE AND POWER-SAVING METHOD OF MULTIMEDIA TRANSMISSION AND SYSTEM THEREOF

(71) Applicant: HUIZHOU TCL MOBILE COMMUNICATION CO., LTD., HUIZHOU (CN)

(72) Inventors: Zhuolun Xie, HUIZHOU (CN); Jie Zhang, HUIZHOU (CN)

(21) Appl. No.: 14/770,285

(22) PCT Filed: May 30, 2014
(86) PCT No.: PCT/CN2014/078865

§ 371 Date: Aug. 25, 2015

(30) Foreign Application Priority Data
Mar. 28, 2014 (CN) 201410121850.7

(51) Int. Cl. H04W 52/02; H04W 76/06; H04W 76/02

(52) U.S. Cl. CPC H04W 52/0251; H04W 52/0225; H04W 76/023; H04W 76/068; H04W 76/028; H04W 84/12

(57) ABSTRACT

A multimode and power-saving method of multimedia transmission may include, when a multimedia terminal is turned on upon receiving an operational command from a user, acquiring a list of a plurality of available connection protocols in a protocol implementation layer, between an application interface layer and a hardware implementation layer of the multimedia terminal. The method may also include acquiring, from the list of available connection protocols, and saving a current most power-saving connection protocol according to a power-saving priority of each connection protocol, and establishing a connection with another terminal using the current most power-saving connection protocol. When a time that the multimedia terminal has not conducted data transmission with another terminal exceeds a preset time threshold value, the multimedia terminal is disconnected from the other terminal.

### TECHNICAL FIELD

The present disclosure relates to wireless multimedia. More particularly, the present disclosure relates to a multimode and power-saving method of multimedia transmission and a system thereof.

### BACKGROUND

Wireless communications and transmission technologies are replacing wired communications at an extremely fast pace. Furthermore, wireless charging makes it unnecessary for many smart phone users to plug into chargers. Moreover, wireless electric switches are increasingly popular in young families. For example, Bluetooth sound systems and headphones are extensively used among young people and business people. At the same time, wireless projection adapters, TVs and projectors of various standards have become new favorites on the market of consumer electronics. AirPlay (a wireless communications technology developed by Apple), DLNA (DIGITAL LIVING NETWORK ALLIANCE launched by Sony, Intel and Microsoft have been developed to address interconnection among wireless networks and wired networks, including personal computers (PCs), consumer electric appliances, and mobile devices, such that it is possible to realize unlimited sharing and growth of digital media and content services). MiraCast (a Wi-Fi CERTIFIED Miracas certification program announced and launched by the Wi-Fi Alliance on Sep. 19, 2012) apparatuses provide simplified discovery and settings, and users can transmit videos among the apparatuses rapidly. As a result, people can get rid of the restriction by wired power transmission and data transmission and achieve the freedom of using electronic apparatuses at any time and at any place.

Along with the update of application content via wireless transmission, issues like power consumption and usage time of wireless transmission cannot meet user demand. For example, a cell phone connected to a Bluetooth stereo headphone will have 15% to 20% less usage time than a cell phone with the Bluetooth function closed. A difference of system average current is around 200 mA between a cell phone with wifi on and a cell phone with wifi off, and an associated usage time is shortened by 40%. In wireless projection applications, an average standby and operating current are not optimized for a regular standard wireless projection adapter, with a typical value between 300 mA and 500 mA. Such a power management strategy is not favorable for effective use of energy and environmental protection.

Therefore, the prior art is in need of improvement and development.

### SUMMARY

In light of the above drawbacks of the prior art, the objects of the present invention are to provide a multimode and power-saving method of multimedia transmission and a system thereof, thereby, solving the problems of the prior art.

A multimode and power-saving method of multimedia transmission includes, when a multimedia terminal is turned on upon receiving an operational command from a user, acquiring a list of a plurality of available connection protocols in a protocol implementation layer between an application interface layer and a hardware implementation layer of a multimedia terminal; upon receiving the operational command from the user, the multimedia terminal acquires and saves a most power-saving connection protocol according to a power-saving priority of each connection protocol in said list of the plurality of available connection protocols, and establishes connection with another terminal using a current most power-saving connection protocol; when a time that said multimedia terminal has not conducted data transmission with another terminal exceeds a preset time threshold value, said multimedia terminal is disconnected from another terminal.

In another embodiment, a multimode and power-saving method of multimedia transmission includes upon receiving an operational command from a user, a multimedia terminal that sets a time threshold value.

In a further embodiment, a multimode and power-saving method of multimedia transmission includes a multimedia terminal that acquires a most power-saving connection protocol according to a power-saving priority of each connection protocol in a list of a plurality of available connection protocols; and acquires a data structure of the most power-saving connection protocol and saving the data structure; wherein the multimedia terminal establishes connection with another terminal according to the most power-saving connection protocol and starts to conduct data transmission.

In yet another embodiment, a multimode and power-saving method of multimedia transmission includes when a multimedia terminal is disconnected from another terminal, the multimedia terminal receives an operational command from a user to re-establish a connection between the multimedia terminal and another terminal to conduct data transmission.

In yet a further embodiment, a multimode and power-saving method of multimedia transmission includes a list of a plurality of available connection protocols that comprises: Bluetooth 2.0/2.1/4.0/4.1 protocols, 802.11 a/b/g/n/ac/ah protocols, a low power consumption wifi protocol, and a Zigbee Protocol.

In another embodiment, a multimode and power-saving method of multimedia transmission includes a data structure that comprises four fields that include: a unified connection ID, an application interface type, a current connection status, and a currently selected protocol type.

In a further embodiment, a multimode and power-saving system of multimedia transmission includes a connection protocol acquisition module for, when a multimedia terminal is turned on upon receiving an operational command from a user, acquiring a list of a plurality of available connection protocols in a protocol implementation layer between an application interface layer and a hardware implementation layer of the multimedia terminal; a connection establishment module for, when the multimedia terminal receives the operational command from the user, acquiring and saving a most power-saving connection protocol according to a power-saving priority of each connection protocol in said list of the plurality of available connection protocols, and establishing connection with another terminal using a current most power-saving connection protocol; and a connection breaking module for, when a time that said multimedia terminal has not conducted data transmission with another terminal exceeds a preset time threshold value, breaking the connection between said multimedia terminal and the other terminal.

In yet another embodiment, a multimode and power-saving system of multimedia transmission includes a setting module for, when a multimedia terminal receives an operational command from a user, setting a time threshold value; and a connection restoring module for, when the multimedia terminal is disconnected from another terminal, the multimedia terminal to receive the operational command from the user to re-establish a connection between the multimedia terminal and another terminal and to conduct data transmission.

In yet a further embodiment, a multimode and power-saving system of multimedia transmission includes a protocol screening unit for a multimedia terminal to acquire a most power-saving connection protocol according to a power-saving priority of each connection protocol in a list of a plurality of available connection protocols; a protocol saving unit for acquiring a data structure of the most power-saving connection protocol and saving the data structure; and a connection unit for the multimedia terminal to establish connection with another terminal according to the most power-saving connection protocol and start to conduct data transmission.

In another embodiment, a multimode and power-saving system of multimedia transmission includes a list of a plurality of available connection protocols that comprises: Bluetooth 2.0/2.1/4.0/4.1 protocols, 802.11 a/b/g/n/ac/ah protocols, a low power consumption wifi protocol, and a Zigbee Protocol.

The present invention provides a multimode and power-saving method of multimedia transmission and a system thereof. The method includes, when a multimedia terminal is turned on upon receiving an operational command from a user, acquiring a list of a plurality of available connection protocols in a protocol implementation layer between an application interface layer and a hardware implementation layer of the multimedia terminal; in said list of the plurality of available connection protocols, acquiring and saving a most power-saving connection protocol according to a power-saving priority of each connection protocol, and establishing connection with another terminal using a current most power-saving connection protocol; wherein when a time that said multimedia terminal has not conducted data transmission with another terminal exceeds a preset time threshold value, said multimedia terminal is disconnected from the other terminal. Since a most power-saving connection protocol is selected, in the multimedia terminal, for connection with another terminal and the two are disconnected if no data transmission takes place within a period of time, a connection power consumption is effectively reduced, and an associated operating current is optimized. Furthermore, a standby and working time of the multimedia terminal is improved.

### BRIEF DESCRIPTION OF THE DRAWINGS

FIG. 1 depicts a flow chart of an exemplary embodiment of a multimode and power-saving method of multimedia transmission according to the present invention;

FIG. 2 depicts a detailed flow chart of an exemplary multimedia terminal receiving an operational command from a user to acquire and save a most power-saving connection protocol, and to establish connection with another terminal according to the present invention; and

FIG. 3 depicts a structural block diagram of an exemplary embodiment of a multimode and power-saving system of multimedia transmission according to the present invention.

### DETAILED DESCRIPTION

A multimode and power-saving method of multimedia transmission, and system thereof, are provided. To make the objects, technical solutions, and effects clear, the present invention will be further described in detail below with reference to the accompanying figures. It should be understood that the exemplary embodiments included herein are for illustrative purposes. The exemplary embodiments are not intended to limit the present invention in any way.

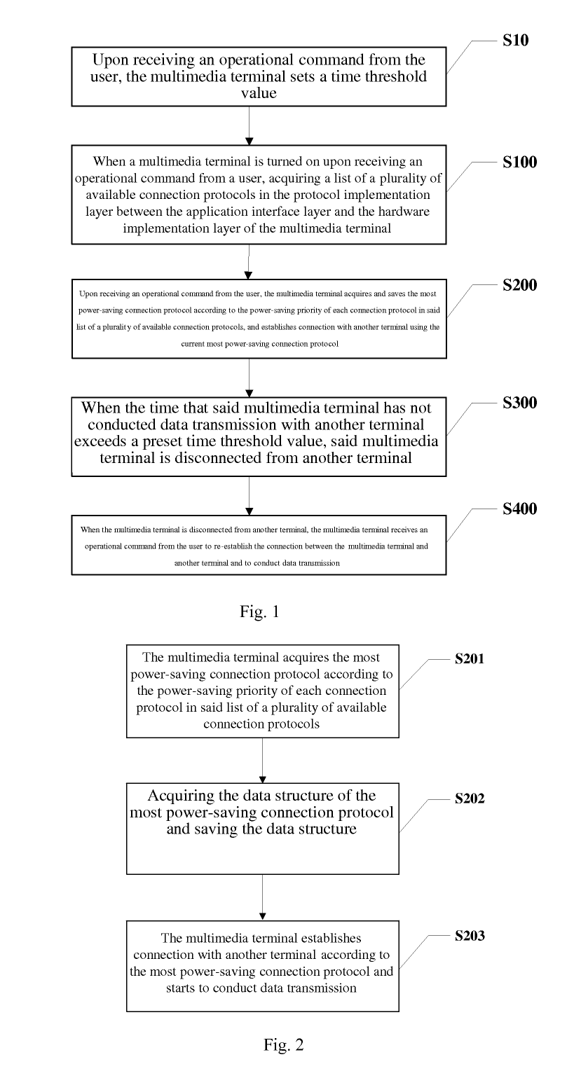

With reference to FIG. 1, a flow chart of a multimode and power-saving method of multimedia transmission may include, when a multimedia terminal is turned on upon receiving an operational command from a user, acquiring a list of a plurality of available connection protocols in a protocol implementation layer between an application interface layer and a hardware implementation layer of the multimedia terminal (block S100). By acquiring a list of a plurality of available connection protocols in the multimedia terminal, the multimedia terminal can select one connection protocol in the list to establish connection with another terminal and to conduct data transmission. The method may also include, upon receiving the operational command from the user, the multimedia terminal may acquire and may save a most power-saving connection protocol according to a power-saving priority of each connection protocol in the list of the plurality of available connection protocols, and may establish connection with another terminal using a current most power-saving connection protocol (block S200). Thereby, a power strategy of the terminal may be optimized from the protocol layer that the multimedia terminal selects, and the most power-saving connection protocol thereof may be selected according to the power-saving priority of each connection protocol. Accordingly, the mobile terminal may establish connection with another terminal using the current most power-saving connection protocol.

When a time that the multimedia terminal has not conducted data transmission with another terminal exceeds a preset time threshold value, the multimedia terminal may be automatically disconnected from another terminal (block S300).

A plurality of available connection protocols may be acquired in the multimedia terminal, and the most power-saving connection protocol may be selected for connection with another terminal. A most power-saving connection protocol may be selected in the protocol implementation layer. During a course of data transmission between the multimedia terminal and another terminal, the connection of the two may be broken after a period of time that there is no data transmission between the two. For example, a data connection module of the multimedia terminal may enter a sleep mode, which may achieve power saving through a sleeping mode in a hardware implementation layer.

Upon receiving an operational command from the user, the multimedia terminal may set a time threshold value (block S10). A time threshold value may be defined and set by the user, which may be set to an always power-saving link, a 10 min. power-saving link, a 5 min. power-saving link, a 2 min. power-saving link, and 1 min. power-saving link, when it is determined that a duration of a state that there is no data transmission between the multimedia terminal and another terminal exceeds the time threshold value defined and set by the user. Accordingly, the data connection module of the multimedia terminal may enter the sleep mode. When the data connection module of the multimedia terminal is in the sleep mode, the user may set a second time threshold value according to an actual usage need. Accordingly, when a duration of a broken connection between the multimedia terminal and another terminal exceeds the second time threshold value, the connection between the multimedia terminal and the other terminal may be restored. Alternatively, the second time threshold value may not be set, and a connection between the multimedia terminal and another terminal may be restored manually. For example, when the multimedia terminal is disconnected from another terminal, the multimedia terminal may receive an operational command from the user to re-establish the connection between the multimedia terminal and another terminal to conduct data transmission (block S400). Accordingly, the multimedia terminal may be awakened from the sleep mode by means of manual operations, which can restore the data connection with another terminal in a very short time, and to further conduct data transmission. In accordance with the effective power management strategy according to the method of FIG. 1, there may be no impact on an associated normal data transmission process, and a standby time and/or a working time of the multimedia terminal may be extended.

Turning to FIG. 2, the multimedia terminal may acquire a most power-saving connection protocol according to a power-saving priority of each connection protocol in a list of a plurality of available connection protocols (block S201). The mobile terminal may acquire a data structure of the most power-saving connection protocol and may save the data structure (block S202). The multimedia terminal may establish connection with another terminal according to the most power-saving connection protocol and may start to conduct data transmission (block S203). The list of the plurality of available connection protocols may include: Bluetooth 2.0/2.1/4.0/4.1 protocols, 802.11 a/b/g/n/ac/ah protocols, a low power consumption wifi protocol, and/or a Zigbee Protocol. The Bluetooth 2.0 protocol may be an improved version of 1.2, a transmission rate may be in a range of 1.8 M/s-2.1 M/s, and there may be a duplex operation mode, i.e. audio communications and transmission of files or images are carried out simultaneously.

Relative to Bluetooth 2.0, Bluetooth 2.1 may be added with a “Sniff Subrating” technology, i.e. a “low power consumption monitoring mode”. For hardware devices that require continuous transmission of data streams, such as a keyboard, a mouse, a watch, etc., this technology can extend a battery life by as much as 5 times. Bluetooth 2.1 may simplify a pairing process among apparatuses. The Bluetooth 4.0 may be an upgraded version of Bluetooth 3.0, and relative to the 3.0 version, the 4.0 version may be more power saving, may have a lower cost, may have a 3 ms low delay, may have a very long effective connection distance, and may have AES-128 encryption. Bluetooth 4.0 is usually used on apparatuses like Bluetooth headphones and Bluetooth loudspeakers. One of the most important features of Bluetooth 4.0 is power saving. For example, extremely low operation and standby power consumption may enable a button battery to continuously run for as long as several years. Bluetooth 4.1 may be an upgraded version of 4.0, may have a faster batch data transmission rate, and at the same time, may have more powerful communication functions. The 802.11b/g protocols, and low power consumption wifi protocol and 802.11ah protocols may be standards for wireless local area networks, with differences in operation frequency band, data transmission rate, and/or a power saving feature.

A data structure may have four fields, including: a unified connection ID, an application interface type, a current connection status and a currently selected protocol type. The unified connection ID may be generated sequentially. The application interface type may store a calling type of an application interface that may be used as a basis for selection of available connections. The current connection status may have several statuses, including: an unpaired status, a connection ready status, an in transmission status, a remote response status, and a connection broken status. The currently selected protocol may be a type of a selected transmission protocol that is the most effective.

In an exemplary implementation, a presenter may use a wireless projector to project a presentation from a laptop computer. The laptop computer may, for example, acquire a list of a plurality of available connection protocols in a protocol implementation layer between an application interface layer and a hardware implementation layer of the multimedia terminal. For example, the available connection protocols may include: Bluetooth 2.0/2.1/4.0/4.1 protocols, 802.11 a/b/g/n/ac/ah protocols, a low power consumption wifi protocol, and/or a Zigbee Protocol. The laptop computer may, for example, select a most power-saving connection protocol according to power-saving priorities of all connection protocols in the list of available connection protocols, such as the low power consumption wifi protocol. When the protocol is selected, connection may be established between a wireless connection module at a source end of the laptop computer and a wireless connection module at a receiving end of the wireless projector according to the selected connection protocol. The laptop computer may transmit data of a current page of a presentation to the wireless projector via the wireless connection module at the source end. The data of the current page of the presentation may be cached in a memory module of the wireless projector, and at this time, the presenter may talk about the current page for a long time without changing the page. Thus, the laptop computer may determine if a time that there is no data transmission between the laptop computer and the wireless projector exceeds a preset time threshold value. If the laptop computer determines that there is no data transmission between the laptop computer and the wireless projector for a time period that exceeds the preset time threshold, both the wireless connection module at the source end and the wireless connection module at the receiving end may enter a sleep mode, and a connection between the laptop computer and the wireless projector may be temporarily broken. When the presenter stays on discussing the content of the current page for a long time, the connection between the laptop computer and the wireless projector may continue to be broken. When the presenter operates the laptop computer to, for example, choose another page, both the wireless connection module at the source end and the wireless connection module at the receiving end may be immediately awakened from the sleep mode, and the laptop computer may re-establish connection with the wireless projector to conduct data transmission. Since the power saving strategy, in the exemplary embodiment, is employed at both the protocol layer and the hardware layer, a standby time and a working time of the multimedia terminal may be significantly extended.

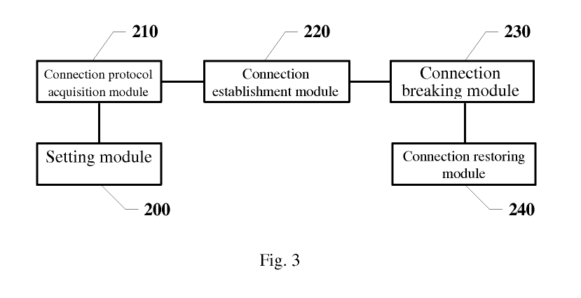

Turning to FIG. 3, a multimode and power-saving system of multimedia transmission may include a connection protocol acquisition module 210 for, when a multimedia terminal is turned on upon receiving an operational command from a user, acquiring a list of a plurality of available connection protocols in a protocol implementation layer between an application interface layer and a hardware implementation layer of the multimedia terminal. The multimode and power-saving system of multimedia transmission may also include a connection establishment module 220 for, when the multimedia terminal receives an operational command from the user, acquiring and saving a most power-saving connection protocol according to a power-saving priority of each connection protocol in the list of the plurality of available connection protocols, and may establish connection with another terminal using the current most power-saving connection protocol. The multimode and power-saving system of multimedia transmission may further include a connection breaking module 230 for, when a time that the multimedia terminal has not conducted data transmission with another terminal exceeds a preset time threshold value, breaking a connection between the multimedia terminal and the other terminal.

The multimode and power-saving system of multimedia transmission may yet further include a setting module 200 for, when the multimedia terminal receives an operational command from the user, setting a time threshold value. The multimode and power-saving system of multimedia transmission may also include a connection restoring module 240 for, when the multimedia terminal is disconnected from another terminal, the multimedia terminal may receive an operational command from the user to re-establish a connection between the multimedia terminal and another terminal to conduct data transmission.

The connection establishment module 220 may include a protocol screening unit for the multimedia terminal to acquire a most power-saving connection protocol according to a power-saving priority of each connection protocol in a list of a plurality of available connection protocols. The connection establishment module 220 may also include a protocol saving unit for acquiring a data structure of the most power-saving connection protocol and for saving the data structure. The connection establishment module 220 may also include a connection unit for the multimedia terminal to establish connection with another terminal according to the most power-saving connection protocol, and may start to conduct data transmission. A list of a plurality of available connection protocols may include: Bluetooth 2.0/2.1/4.0/4.1 protocols, 802.11 a/b/g/n/ac/ah protocols, a low power consumption wifi protocol, and/or a Zigbee Protocol.

In summary, a multimode and power-saving method of multimedia transmission and a system thereof are provided. The method may include, when a multimedia terminal is turned on upon receiving an operational command from a user, acquiring a list of a plurality of available connection protocols in a protocol implementation layer between an application interface layer and a hardware implementation layer of the multimedia terminal; in said list of the plurality of available connection protocols, acquiring and saving a most power-saving connection protocol according to a power-saving priority of each connection protocol, and establishing connection with another terminal using a current most power-saving connection protocol; wherein when a time that said multimedia terminal has not conducted data transmission with another terminal exceeds a preset time threshold value, said multimedia terminal is disconnected from the other terminal. Since a most power-saving connection protocol may be selected, in the multimedia terminal, for connection with another terminal and the two may be disconnected if no data transmission takes place within a period of time, a connection power consumption may be effectively reduced, and an associated optimizes the operating current may be optimized. Furthermore, standby and working time of the multimedia terminal may be improved.

It should be understood that applications of the present invention are not limited to the above examples. To those skilled in the art, improvements or modifications may be made according to the above description, and all of these improvements or modifications shall be encompassed by the appended claims.

1. A multimode and power-saving method of multimedia transmission, the method comprising:
when a multimedia terminal is turned on upon receiving an operational command from a user, acquiring a list of a plurality of available connection protocols in a protocol implementation layer between an application interface layer and a hardware implementation layer of a multimedia terminal;
upon receiving the operational command from the user, the multimedia terminal acquires and saves a most power-saving connection protocol according to a power-saving priority of each connection protocol in said list of the plurality of available connection protocols, and establishes connection with another terminal using a current most power-saving connection protocol;
when a time that said multimedia terminal has not conducted data transmission with another terminal exceeds a preset time threshold value, said multimedia terminal is disconnected from the other terminal.

2. The multimode and power-saving method of multimedia transmission according to claim 1, further comprising:
upon receiving the operational command from the user, the multimedia terminal sets a time threshold value.

3. The multimode and power-saving method of multimedia transmission according to claim 1, wherein
the multimedia terminal acquires the most power-saving connection protocol according to the power-saving priority of each connection protocol in said list of the plurality of available connection protocols; and
acquires a data structure of the most power-saving connection protocol and saving the data structure; wherein
the multimedia terminal establishes connection with another terminal according to the most power-saving connection protocol and starts to conduct data transmission.

4. The multimode and power-saving method of multimedia transmission according to claim 1, further comprising:
when the multimedia terminal is disconnected from another terminal, the multimedia terminal receives the operational command from the user to re-establish a connection between the multimedia terminal and another terminal to conduct data transmission.

5. The multimode and power-saving method of multimedia transmission according to claim 1, wherein said list of the plurality of available connection protocols comprises: Bluetooth 2.0/2.1/4.0/4.1 protocols, 802.11 a/b/g/n/ac/ah protocols, a low power consumption wifi protocol, and a Zigbee Protocol.

6. The multimode and power-saving method of multimedia transmission according to claim 3, wherein the data structure comprises four fields including: a unified connection ID, an application interface type, a current connection status, and a currently selected protocol type.

7. A multimode and power-saving method of multimedia transmission according to claim 1, further comprising:
upon receiving the operational command from the user, the multimedia terminal sets a time threshold value;
and, when the multimedia terminal is disconnected from another terminal, the multimedia terminal receives the operational command from the user to re-establish a connection between the multimedia terminal and another terminal to conduct data transmission.

8. The multimode and power-saving method of multimedia transmission according to claim 7, wherein:
the multimedia terminal acquires the most power-saving connection protocol according to the power-saving priority of each connection protocol in said list of the plurality of available connection protocols; and
acquires a data structure of the most power-saving connection protocol and saving the data structure; wherein
the multimedia terminal establishes connection with another terminal according to the most power-saving connection protocol and starts to conduct data transmission.

9. The multimode and power-saving method of multimedia transmission according to claim 7, wherein said list of the plurality of available connection protocols comprises: Bluetooth 2.0/2.1/4.0/4.1 protocols, 802.11 a/b/g/n/ac/ah protocols, a low power consumption wifi protocol, and a Zigbee Protocol.

10. The multimode and power-saving method of multimedia transmission according to claim 7, wherein the data structure comprises four fields including: a unified connection ID, an application interface type, a current connection status, and a currently selected protocol type.

11. The multimode and power-saving method of multimedia transmission according to claim 7, wherein the time threshold value is 10 minutes, 5 minutes, 2 minutes, or 1 minutes.

12. The multimode and power-saving method of multimedia transmission according to claim 7, further comprising: when a data connection module of the multimedia terminal is in a sleep mode, a second time threshold value is set according to an actual usage need; when a duration of a broken connection between the multimedia terminal and another terminal exceeds the second time threshold value, a connection between the multimedia terminal and another terminal is restored, or the connection between the multimedia terminal and another terminal is restored manually.

13. A multimode and power-saving method of multimedia transmission, the method comprising:
upon receiving an operational command from a user, a multimedia terminal sets a time threshold value;
when the multimedia terminal is turned on upon receiving the operational command from the user, acquiring a list of a plurality of available connection protocols in a protocol implementation layer between an application interface layer and a hardware implementation layer of a multimedia terminal;
upon receiving the operational command from the user, the multimedia terminal acquires and saves a most power-saving connection protocol according to a power-saving priority of each connection protocol in said list of the plurality of available connection protocols, and establishes connection with another terminal using a current most power-saving connection protocol;
when a time that said multimedia terminal has not conducted data transmission with another terminal exceeds a preset time threshold value, said multimedia terminal is disconnected from another terminal; and
when a data connection module of the multimedia terminal is in a sleep mode, a second time threshold value is set according to an actual usage need; when a duration of a broken connection between the multimedia terminal and another terminal exceeds the second time threshold value, a connection between the multimedia terminal and another terminal is restored, or the connection between the multimedia terminal and another terminal is restored manually.

14. A multimode and power-saving system of multimedia transmission, the system comprising:
a connection protocol acquisition module for, when a multimedia terminal is turned on upon receiving an operational command from a user, acquiring a list of a plurality of available connection protocols in a protocol implementation layer between an application interface layer and a hardware implementation layer of the multimedia terminal;
a connection establishment module for, when the multimedia terminal receives the operational command from the user, acquiring and saving a most power-saving connection protocol according to a power-saving priority of each connection protocol in said list of the plurality of available connection protocols, and establishing connection with another terminal using a current most power-saving connection protocol; and
a connection breaking module for, when a time that said multimedia terminal has not conducted data transmission with another terminal exceeds a preset time threshold value, breaking the connection between said multimedia terminal and the other terminal.

15. The multimode and power-saving system of multimedia transmission according to claim 14, further comprising:
a setting module for, when the multimedia terminal receives the operational command from the user, setting a time threshold value; and
a connection restoring module for, when the multimedia terminal is disconnected from another terminal, the multimedia terminal to receive the operational command from the user to re-establish a connection between the multimedia terminal and another terminal and to conduct data transmission.

16. The multimode and power-saving system of multimedia transmission according to claim 14, wherein the connection establishment module comprises:
a protocol screening unit for the multimedia terminal to acquire a most power-saving connection protocol according to a power-saving priority of each connection protocol in said list of the plurality of available connection protocols;
a protocol saving unit for acquiring a data structure of the most power-saving connection protocol and saving the data structure; and
a connection unit for the multimedia terminal to establish connection with another terminal according to the most power-saving connection protocol and start to conduct data transmission.

17. The multimode and power-saving system of multimedia transmission according to claim 14, wherein said list of the plurality of available connection protocols comprises: Bluetooth 2.0/2.1/4.0/4.1 protocols, 802.11 a/b/g/n/ac/ah protocols, a low power consumption wifi protocol, and a Zigbee Protocol.

18. The multimode and power-saving method of multimedia transmission according to claim 13, wherein said list of the plurality of available connection protocols comprises: Bluetooth 2.0/2.1/4.0/4.1 protocols, 802.11 a/b/g/n/ac/ah protocols, a low power consumption wifi protocol, and a Zigbee Protocol.

19. The multimode and power-saving method of multimedia transmission according to claim 13, wherein the data structure comprises four fields including: a unified connection ID, an application interface type, a current connection status, and a currently selected protocol type.

20. The multimode and power-saving method of multimedia transmission according to claim 13, wherein the time threshold value is 10 minutes, 5 minutes, 2 minutes, or 1 minute.
